(19) United States
(12) Patent Application Publication
(10) Pub. No.: US 2020/0302952 A1
(43) Pub. Date: Sep. 24, 2020

(54) SYSTEM FOR ASSESSING VOCAL PRESENTATION

(71) Applicant: AMAZON TECHNOLOGIES, INC., Seattle, WA (US)

(72) Inventors: ALEXANDER JONATHAN PINKUS, SEATTLE, WA (US); DOUGLAS GRADT, WOODWAY, WA (US); SAMUEL ELBERT MCGOWAN, SEATTLE, WA (US); CHAD THOMPSON, SEATTLE, WA (US); CHAO WANG, NEWTON, MA (US); VIKTOR ROZGIC, BELMONT, MA (US)

(21) Appl. No.: 16/359,374

(22) Filed: Mar. 20, 2019

(51) Int. Cl. G10L 25/63; H04W 4/80; G10L 25/90

(52) U.S. Cl. CPC G10L 25/63; G10L 25/90; H04W 4/80

(57) ABSTRACT

A wearable device with a microphone acquires audio data of a wearer's speech. The audio data is processed to determine sentiment data indicative of perceived emotional content of the speech. For example, the sentiment data may include values for one or more of valence that is based on a particular change in pitch over time, activation that is based on speech pace, dominance that is based on pitch rise and fall patterns, and so forth. A simplified user interface provides the wearer with information about the emotional content of their speech based on the sentiment data. The wearer may use this information to assess their state of mind, facilitate interactions with others, and so forth.

### BACKGROUND

Participants in a conversation may be affected by the emotional state of one another as perceived by their voice. For example, if a speaker is excited a listener may perceive that excitement in their speech. However, a speaker may not be aware of the emotional state that may be perceived by others as conveyed by their speech. A speaker may also not be aware of how their other activities affect the emotional state as conveyed by their speech. For example, a speaker may not realize a trend that their speech sounds irritable to others on days following a restless night.

### BRIEF DESCRIPTION OF FIGURES

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 is an illustrative system that processes speech of a user to determine sentiment data that is indicative of an emotional state as conveyed by the speech and presenting output related to that sentiment data, according to one implementation.

FIG. 2 illustrates a block diagram of sensors and output devices that may be used during operation of the system, according to one implementation.

FIG. 3 illustrates a block diagram of a computing device(s) such as a wearable device, smartphone, or other devices, according to one implementation.

FIG. 4 illustrates parts of a conversation between a user and a second person, according to one implementation.

FIG. 5 illustrates a flow diagram of a process of presenting output based on sentiment data obtained from analyzing a user's speech, according to one implementation.

FIG. 6 illustrates a scenario in which user status data such as information about the user's health is combined with the sentiment data to provide an advisory output, according to one implementation.

FIGS. 7 and 8 illustrate several examples of user interfaces with output presented to the user that is based at least in part on the sentiment data, according to some implementations.

While implementations are described herein by way of example, those skilled in the art will recognize that the implementations are not limited to the examples or figures described. It should be understood that the figures and detailed description thereto are not intended to limit implementations to the particular form disclosed but, on the contrary, the intention is to cover all modifications, equivalents, and alternatives falling within the spirit and scope as defined by the appended claims. The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include,” “including,” and “includes” mean including, but not limited to.

### DETAILED DESCRIPTION

A person's wellbeing and emotional state are interrelated. A poor emotional state can directly impact a person's health, just as an illness or other health event may impact a person's emotional state. A person's emotional state may also impact others that they communicate with. For example, a person who speaks with someone in an angry tone may produce in that listener an anxious emotional response.

Information about the emotional state that they are expressing may be useful to helping a person. Continuing the earlier example, if the angry person is speaking to their friend, the friend may let them know. With that awareness, the angry person may then be able to modify their behavior. As useful as this feedback is, it is infeasible to have a friend constantly present who is able to tell a person what the emotional state expressed in their voice is.

Described in this disclosure is a system that processes audio data of a user's speech to determine sentiment data indicative of emotional state and present output in a user interface to the user. The user authorizes the system to process their speech. For example, the user may enroll in the use, and consent to acquisition and processing of audio of the user speaking. Raw audio as acquired from one or more microphones is processed to provide audio data that is associated with a particular user. This audio data is then processed to determine audio feature data. For example, the audio feature data may be processed by a neural network to generate feature vectors representative of the audio data and changes in the audio data. The audio feature data is then processed to determine sentiment data for that particular user. For example, the system discards audio data that is not associated with the particular user and generates the audio feature data from the audio data that is associated with the particular user. After the audio feature data is generated, the audio data of the particular user may be discarded.

A wearable device may be used to acquire the raw audio. For example, the wearable device may comprise a band, bracelet, necklace, earring, brooch, and so forth. The wearable device may comprise one or more microphones and a computing device. The wearable device may be in communication with another device, such as a smartphone. The wearable device may provide audio data to the smartphone for processing. The wearable device may include sensors, such as a heart rate monitor, accelerometer, and so forth. Sensor data obtained by these sensors may be used to determine user status data. For example, accelerometer data may be used to generate user status data indicating how much movement the user has engaged in during the previous day.

In other implementations, the functionality of the system as described may be provided by a single device or distributed across other devices. For example, a server may be accessible via a network to provide some functions that are described herein.

The sentiment data is determined by analyzing characteristics of the user's speech as expressed in the audio feature data. Changes over time in pitch, pace, and so forth may be indicative of various emotional states. For example, the emotional state of speech that is described as “excited” may correspond to speech which has a greater pace while slower paced speech is described as “bored”. In another example, an increase in average pitch may be indicative of an emotional state of “angry” while an average pitch that is close to a baseline value may be indicative of an emotional state of “calm”. Various techniques may be used individually or in combination to determine the sentiment data including, but not limited to, signal analysis techniques, classifiers, neural networks, and so forth. The sentiment data may be provided as numeric values, vectors, associated words, and so forth.

The sentiment data produced from the audio data of the user may be used to provide output. For example, the output may comprise a graphical user interface (GUI), a voice user interface, an indicator light, a sound, and so forth that is presented to a user by an output device. Continuing the example, the sentiment data may comprise a GUI presented on a display of the phone that shows an indication of the user's tone or overall emotional state as conveyed by their voice based on audio data sampled from the previous 15 minutes. This indication may be a numerical value, chart, or particular color. For example, the sentiment data may comprise various values that are used to select a particular color. An element on the display of the phone or a multi-color light emitting diode on the wearable device may be operated to output that particular color, providing the user with an indication of what emotional state their voice appears to be conveying.

The output may be indicative of sentiment data over various spans of time, such as the past few minutes, during the last scheduled appointment, during the past day, and so forth. The sentiment data may be based on audio acquired from conversations with others, the user talking to themselves, or a combination. As a result, the user may be able to better assess and modify their overall mood, behavior, and interactions with others. For example, the system may alert the user when the sound of their speech indicates they are in an excitable state, giving them the opportunity to calm down.

The system may use the sentiment data and the user status data to provide advisories. For example, the user status data may include information such as hours of sleep, heart rate, number of steps taken, and so forth. The sentiment data and sensor data acquired over several days may be analyzed and used to determine that when the user status data indicates a night with greater than 7 hours of rest, the following day the sentiment data indicates the user is more agreeable and less irritable. The user may then be provided with output in a user interface that is advisory, suggesting the user get more rest. These advisories may help a user to regulate their activity, provide feedback to make healthy lifestyle changes, and maximize the quality of their health.

### Illustrative System

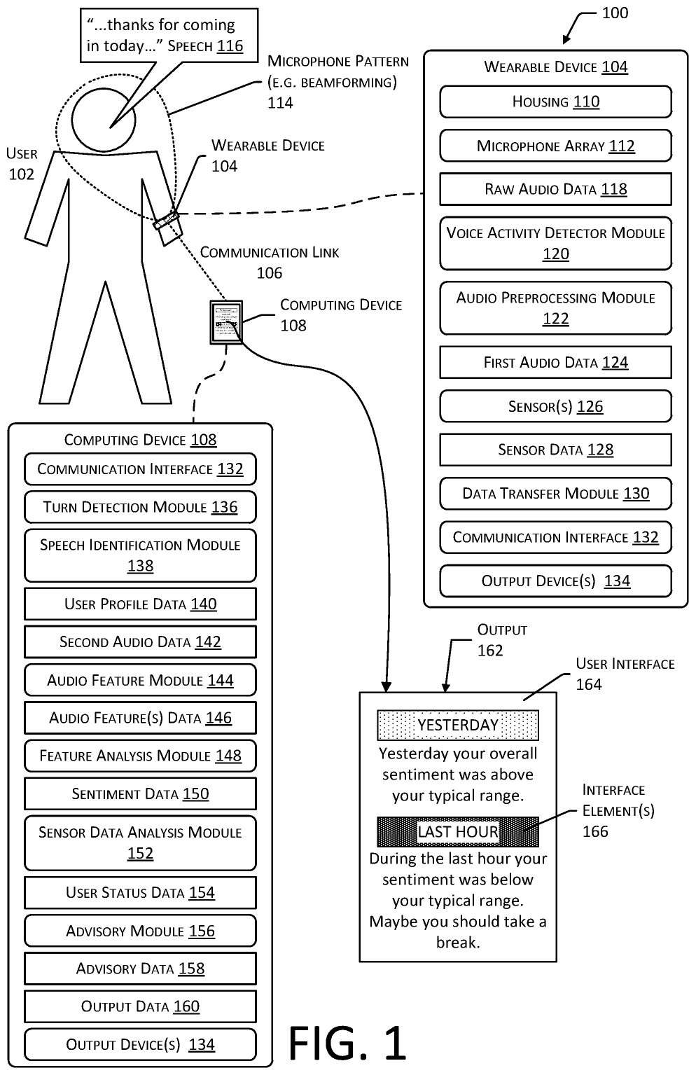

FIG. 1 is an illustrative system 100 that processes speech of a user to determine sentiment data that is indicative of an emotional state as conveyed by the speech and presenting output related to that sentiment data, according to one implementation.

The user 102 may have one or more wearable devices 104 on or about their person. The wearable device 104 may be implemented in various physical form factors including, but not limited to, the following: hats, headbands, necklaces, pendants, brooches, torcs, armlets, brassards, bracelets, wristbands, and so forth. In this illustration, the wearable device 104 is depicted as a wristband.

The wearable device 104 may use a communication link 106 to maintain communication with a computing device 108. For example, the computing device 108 may include a phone, tablet computer, personal computer, server, internet enabled device, voice activated device, smart-home device, and so forth. The communication link 106 may implement at least a portion of the Bluetooth Low Energy specification.

The wearable device 104 includes a housing 110. The housing 110 comprises one or more structures that support a microphone array 112. For example, the microphone array 112 may comprise two or more microphones arranged to acquire sound from ports at different locations through the housing 110. As described below, a microphone pattern 114 may provide gain or directivity using a beamforming algorithm. Speech 116 by the user 102 or other sources within range of the microphone array 112 may be detected by the microphone array 112 and raw audio data 118 may be acquired. In other implementations raw audio data 118 may be acquired from other devices.

A voice activity detector module 120 may be used to process the raw audio data 118 and determine if speech 116 is present. For example, the microphone array 112 may obtain raw audio data 118 that contains ambient noises such as traffic, wind, and so forth. Raw audio data 118 that is not deemed to contain speech 116 may discarded. Resource consumption is minimized by discarding raw audio data 118 that does not contain speech 116. For example, power consumption, demands for memory and computational resources, communication bandwidth, and so forth are minimized by limiting further processing raw audio data 118 determined to not likely contain speech 116.

The voice activity detector module 120 may use one or more techniques to determine voice activity. For example, characteristics of the signals present in the raw audio data 118 such as frequency, energy, zero-crossing rate, and so forth may be analyzed with respect to threshold values to determine characteristics that are deemed likely to be human speech.

Once at least a portion of the raw audio data 118 has been determined to contain speech 116, an audio preprocessing module 122 may further process this portion to determine first audio data 124. In some implementations, the audio preprocessing module 122 may apply one or more of a beamforming algorithm, noise reduction algorithms, filters, and so forth to determine the first audio data 124. For example, the audio preprocessing module 122 may use a beamforming algorithm to provide directivity or gain and improve the signal to noise ratio (SNR) of the speech 116 from the user 102 with respect to speech 116 or noise from other sources.

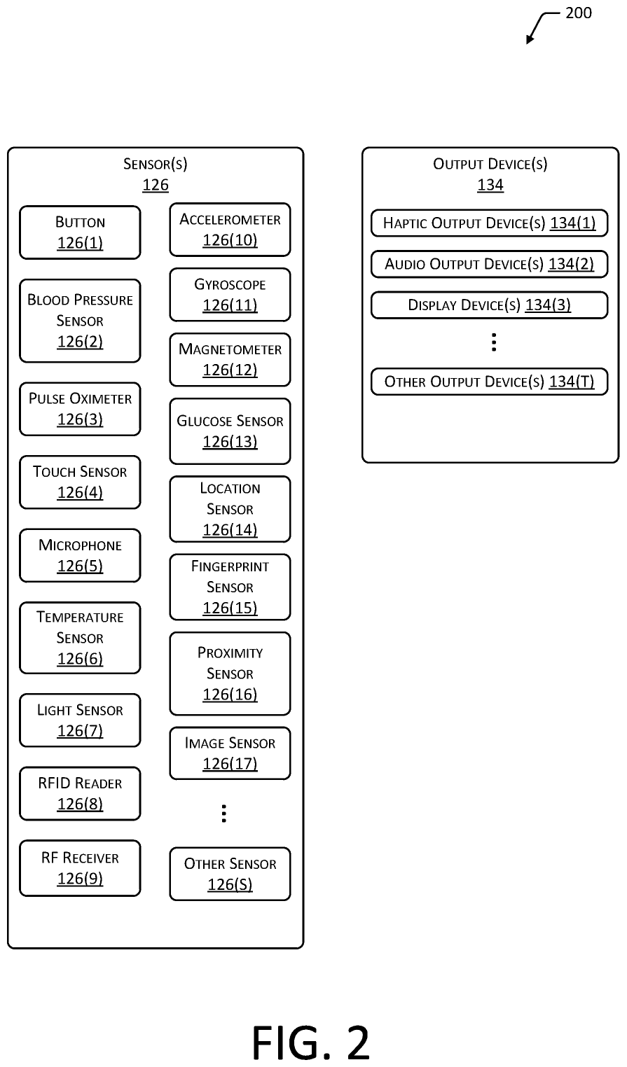

The wearable device 104 may include one or more sensors 126 that generate sensor data 128. For example, the sensors 126 may include accelerometers, pulse oximeters, and so forth. The sensors 126 are discussed in more detail with regard to FIG. 2.

The audio preprocessing module 122 may use information from one or more sensors 126 during operation. For example, sensor data 128 from an accelerometer may be used to determine orientation of the wearable device 104. Based on the orientation, the beamforming algorithm may be operated to provide a microphone pattern 114 that includes a location where the user's 102 head is expected to be.

A data transfer module 130 may use a communication interface 132 to send the first audio data 124, sensor data 128, or other data to the computing device 108 using the communication link 106. For example, the data transfer module 130 may determine that a memory within the wearable device 104 has reached a predetermined quantity of stored first audio data 124. The communication interface 132 may comprise a Bluetooth Low Energy device that is operated responsive to commands from the data transfer module 130 to send the stored first audio data 124 to the computing device 108.

In some implementations the first audio data 124 may be encrypted prior to transmission over the communication link 106. The encryption may be performed prior to storage in the memory of the wearable device 104, prior to transmission via the communication link 106, or both.

Communication between the wearable device 104 and the computing device 108 may be persistent or intermittent. For example, the wearable device 104 may determine and store first audio data 124 even while the communication link 106 to the computing device 108 is unavailable. At a later time, when the communication link 106 is available, the first audio data 124 may be sent to the computing device 108.

The wearable device 104 may include one or more output devices 134. For example, the output devices 134 may include a light emitting diode, haptic output device, speaker, and so forth. The output devices 134 are described in more detail with regard to FIG. 2.

The computing device 108 may include a communication interface 132. For example, the communication interface 132 of the computing device 108 may comprise a Bluetooth Low Energy device, a WiFi network interface device, and so forth. The computing device 108 receives the first audio data 124 from the wearable device 104 via the communication link 106.

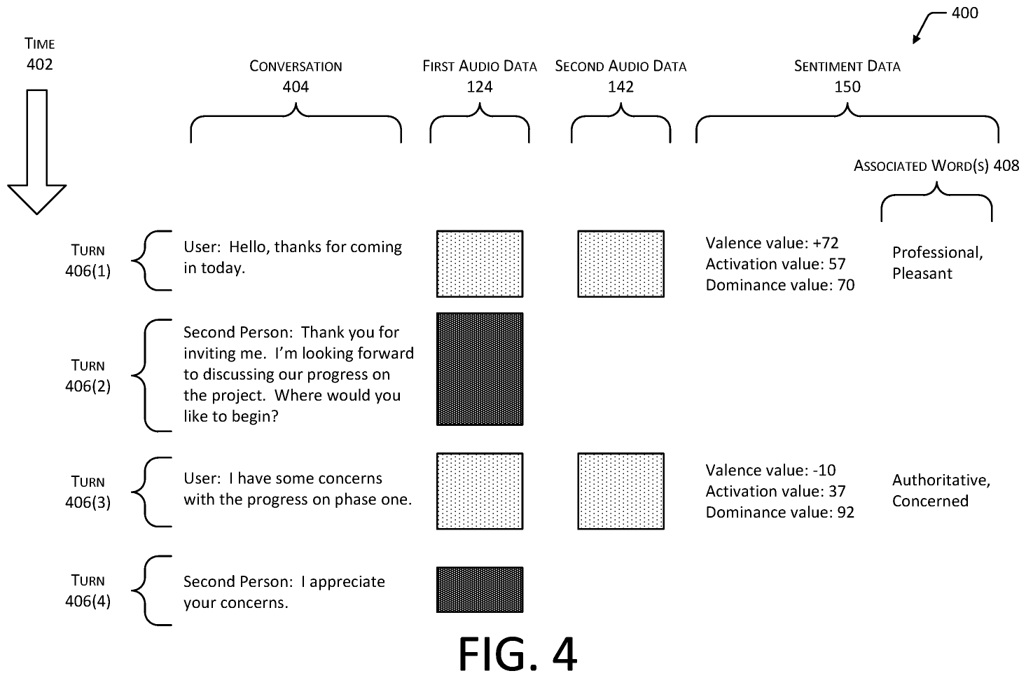

The computing device 108 may use a turn detection module 136 to determine that portions of the first audio data 124 are associated with different speakers. As described in more detail below with regard to FIG. 4, when more than one person is speaking a “turn” is a contiguous portion of speech by a single person. For example, a first turn may include several sentences spoken by a first person, while a second turn includes a response by the second person. The turn detection module 136 may use one or more characteristics in the first audio data 124 to determine that a turn has taken place. For example, a turn may be detected based on a pause in speech 116, change in pitch, change in signal amplitude, and so forth. Continuing the example, if the pause between words exceeds 350 milliseconds, data indicative of a turn may be determined.

In one implementation the turn detection module 136 may process segments of the first audio data 124 to determine if the person speaking at the beginning of the segment is the same as the person speaking at the end. The first audio data 124 may be divided into segments and subsegments. For example, each segment may be six seconds long with a first subsegment that includes a beginning two seconds of the segment and a second subsegment that includes the last two seconds of the segment. The data in the first subsegment is processed to determine a first set of features and the data in the second subsegment is processed to determine a second set of features. Segments may overlap, such that at least some data is duplicated between successive segments. If the first set of features and the second set of features are determined to be within a threshold value of one another, they may be deemed to have been spoken by the same person. If the first set of features and the second set of features are not within the threshold value of one another, they may be deemed to have been spoken by different people. A segment that includes speech from two different people may be designated as a break between one speaker and another. In this implementation, those breaks between speakers may be used to determine the boundaries of a turn. For example, a turn may be determined to begin and end when a segment includes speech from two different people.

In some implementations the turn detection module 136 may operate in conjunction with, or as part of, a speech identification module 138, as described below. For example, if the speech identification module 138 identifies that a first segment is spoken by a first user and a second segment is spoken by a second user, data indicative of a turn may be determined.

The speech identification module 138 may access user profile data 140 to determine if the first audio data 124 is associated with the user 102. For example, user profile data 140 may comprise information about speech 116 provided by the user 102 during an enrollment process. During enrollment, the user 102 may provide a sample of their speech 116 which is then processed to determine features that may be used to identify if speech 116 is likely to be from that user 102.

The speech identification module 138 may process at least a portion of the first audio data 124 that is designated as a particular turn to determine if the user 102 is the speaker. For example, the first audio data 124 of the first turn may be processed by the speech identification module 138 to determine a confidence level of 0.97 that the first turn is the user 102 speaking. A threshold confidence value of 0.95 may be specified. Continuing the example, the first audio data 124 of the second turn may be processed by the speech identification module 138 that determines a confidence level of 0.17 that the second turn is the user 102 speaking.

Second audio data 142 is determined that comprises the portion(s) of the first audio data 124 that is determined to be speech 116 from the user 102. For example, the second audio data 142 may consist of the speech 116 which exhibits a confidence level greater than the threshold confidence value of 0.95. As a result, the second audio data 142 omits speech 116 from other sources, such as someone who is in conversation with the user 102.

An audio feature module 144 uses the second audio data 142 to determine audio feature data 146. For example, the audio feature module 144 may use one or more systems such as signal analysis, classifiers, neural networks, and so forth to generate the audio feature data 146. The audio feature data 146 may comprise values, vectors, and so forth. For example, the audio feature module 144 may use a convolutional neural network that accepts as input the second audio data 142 and provides as output vectors in a vector space. The audio feature data 146 may be representative of features such as rising pitch over time, speech cadence, energy intensity per phoneme, duration of a turn, and so forth.

A feature analysis module 148 uses the audio feature data 146 to determine sentiment data 150. Human speech involves a complex interplay of biological systems on the part of the person speaking. These biological systems are affected by the physical and emotional state of the person. As a result, the speech 116 of the user 102 may exhibit changes. For example, a person who is calm sounds different from a person who is excited. This may be described as “emotional prosody” and is separate from the meaning of the words used. For example, in some implementations the feature analysis module 148 may use the audio feature data 146 to assess emotional prosody without assessment of the actual content of the words used.

The feature analysis module 148 determines the sentiment data 150 that is indicative of a possible emotional state of the user 102 based on the audio feature data 146. The feature analysis module 148 may determine various values that are deemed to be representative of emotional state. In some implementations these values may be representative of emotional primitives. (See Kehrein, Roland. (2002). The prosody of authentic emotions. 27. 10.1055/s-2003-40251.) For example, the emotional primitives may include valence, activation, and dominance. A valence value may be determined that is representative of a particular change in pitch of the user's voice over time. Certain valence values indicative of particular changes in pitch may be associated with certain emotional states. An activation value may be determined that is representative of pace of the user's speech over time. As with valence values, certain activation values may be associated with certain emotional states. A dominance value may be determined that is representative of rise and fall patterns of the pitch of the user's voice over time. As with valence values, certain dominance values may be associated with certain emotional states. Different values of valence, activation, and dominance may correspond to particular emotions. (See Grimm, Michael (2007). Primitives-based evaluation and estimation of emotions in speech. Speech Communication 49 (2007) 787-800.)

Other techniques may be used by the feature analysis module 148. For example, the feature analysis module 148 may determine Mel Frequency Cepstral Coefficients (MFCC) of at least a portion of the second audio data 142. The MFCC may then be used to determine an emotional class associated with the portion. The emotional class may include one or more of angry, happy, sad, or neutral. (See Rozgic, Viktor, et. al, (2012). Emotion Recognition using Acoustic and Lexical Features. 13th Annual Conference of the International Speech Communication Association 2012, INTERSPEECH 2012. 1.).

In other implementations the feature analysis module 148 may include analysis of the words spoken and their meaning. For example, an automated speech recognition (ASR) system may be used to determine the text of the words spoken. This information may then be used to determine the sentiment data 150. For example, presence in the second audio data 142 of words that are associated with a positive connotation, such as compliments or praise, may be used to determine the sentiment data 150. In another example, word stems may be associated with particular sentiment categories. The word stems may be determined using ASR, and the particular sentiment categorizes determined. (See Rozgic, Viktor, et. al, (2012). Emotion Recognition using Acoustic and Lexical Features. 13th Annual Conference of the International Speech Communication Association 2012, INTERSPEECH 2012. 1.). Other techniques may be used determine emotional state based at least in part on the meaning of words spoken by the user.

The sentiment data 150 determined by the feature analysis module 148 may be expressed as one or more numeric values, vectors, words, and so forth. For example, the sentiment data 150 may comprise a composite single value, such as a numeric value, color, and so forth. For example, a weighted sum of the valence, activation, and dominance values may be used to generate an overall sentiment index or “tone value” or “mood value”. In another example, the sentiment data 150 may comprise one or more vectors in an n-dimensional space. In yet another example, the sentiment data 150 may comprise associated words that are determined by particular combinations of other values, such as valence, activation, and dominance values. The sentiment data 150 may comprise values that are non-normative. For example, a sentiment value that is expressed as a negative number may not be representative of an emotion that is considered to be bad.

The computing device 108 may include a sensor data analysis module 152. The sensor data analysis module 152 may process the sensor data 128 and generate user status data 154. For example, the sensor data 128 obtained from sensors 126 on the wearable device 104 may comprise information about movement obtained from an accelerometer, pulse rates obtained from a pulse oximeter, and so forth. The user status data 154 may comprise information such as total movement by the wearable device 104 during particular time intervals, pulse rates during particular time intervals, and so forth. The user status data 154 may provide information that is representative of the physiological state of the user 102.

An advisory module 156 may use the sentiment data 150 and the user status data 154 to determine advisory data 158. The sentiment data 150 and the user status data 154 may each include timestamp information. Sentiment data 150 for a first time period may be associated with user status data 154 for a second time period. Historical data may be used to determine trends. These trends may then be used by the advisory module 156 to determine advisory data 158. For example, trend data may indicate that when the user status data 154 indicates that the user 102 sleeps for fewer than 7 hours per night, the following day their overall tone value is below their personal baseline value. As a result, the advisory module 156 may generate advisory data 158 to inform the user 102 of this and suggest more rest.

In some implementations the advisory data 158 may include speech recommendations. These speech recommendations may include suggestions as to how the user 102 may manage their speech to change or moderate the apparent emotion presented by their speech. In some implementations, the speech recommendations may advise the user 102 to speak more slowly, pause, breath more deeply, suggest a different tone of voice, and so forth. For example, if the sentiment data 150 indicates that the user 102 appears to have been upset, the advisory data 158 may be for the user 102 to stop speaking for ten seconds and then continue speaking in a calmer voice. In some implementations the speech recommendations may be associated with particular goals. For example, the user 102 may wish to sound more assertive and confident. The user 102 may provide input that indicates these goals, with that input used to set minimum threshold values for use by the advisory module 156. The advisory module 156 may analyze the sentiment data 150 with respect to these minimum threshold values to provide the advisory data 158. Continuing the example, if the sentiment data 150 indicates that the speech of the user 102 was below the minimum threshold values, the advisory data 158 may inform the user 102 and may also suggest actions.

The computing device 108 may generate output data 160 from one or more of the sentiment data 150 or the advisory data 158. For example, the output data 160 may comprise hypertext markup language (HTML) instructions that, when processed by a browser engine, generate an image of a graphical user interface (GUI). In another example, the output data 160 may comprise an instruction to play a particular sound, operate a buzzer, or operate a light to present a particular color at a particular intensity.

The output data 160 may then be used to operate one or more output devices 134. Continuing the examples, the GUI may be presented on a display device, a buzzer may be operated, the light may be illuminated, and so forth to provide output 162. The output 162 may include a user interface 164, such as the GUI depicted here that provides information about the sentiment for yesterday and the previous hour using several interface elements 166. In this example, the sentiment is presented as an indication with respect to a typical range of sentiment associated with the user 102. In some implementations the sentiment may be expressed as numeric values and interface elements 166 with particular colors associated with those numeric values may be presented in the user interface. For example, if the sentiment of the user 102 has one or more values that exceed the user's 102 typical range for a metric associated with being happy, an interface element 166 colored green may be presented. In contrast, if the sentiment of the user 102 has one or more values that are below the user's 102 typical range, an interface element 166 colored blue may be presented. The typical range may be determined using one or more techniques. For example, the typical range may be based on minimum sentiment values, maximum sentiment values, may be specified with respect to an average or linear regression line, and so forth.

The system may provide output 162 based on data obtained over various time intervals. For example, the user interface 164 illustrates sentiment for yesterday and the last hour. The system 100 may present information about sentiment associated with other periods of time. For example, the sentiment data 150 may be presented on a real time or near-real time basis using raw audio data 118 obtained in the last n seconds, where n is greater than zero.

It is understood that the various functions, modules, and operations described in this system 100 may be performed by other devices. For example, the advisory module 156 may execute on a server.

FIG. 2 illustrates a block diagram 200 of sensors 126 and output devices 134 that may be used by the wearable device 104, the computing device 108, or other devices during operation of the system 100, according to one implementation. As described above with regard to FIG. 1, the sensors 126 may generate sensor data 128.

The one or more sensors 126 may be integrated with or internal to a computing device, such as the wearable device 104, the computing device 108, and so forth. For example, the sensors 126 may be built-in to the wearable device 104 during manufacture. In other implementations, the sensors 126 may be part of another device. For example, the sensors 126 may comprise a device external to, but in communication with, the computing device 108 using Bluetooth, Wi-Fi, 3G, 4G, LTE, ZigBee, Z-Wave, or another wireless or wired communication technology.

The one or more sensors 126 may include one or more buttons 126(1) that are configured to accept input from the user 102. The buttons 126(1) may comprise mechanical, capacitive, optical, or other mechanisms. For example, the buttons 126(1) may comprise mechanical switches configured to accept an applied force from a touch of the user 102 to generate an input signal. In some implementations input from one or more sensors 126 may be used to initiate acquisition of the raw audio data 118. For example, activation of a button 126(1) may initiate acquisition of the raw audio data 118.

A blood pressure sensor 126(2) may be configured to provide sensor data 128 that is indicative of the user's 102 blood pressure. For example, the blood pressure sensor 126(2) may comprise a camera that acquires images of blood vessels and determines the blood pressure by analyzing the changes in diameter of the blood vessels over time. In another example, the blood pressure sensor 126(2) may comprise a sensor transducer that is in contact with the skin of the user 102 that is proximate to a blood vessel.

A pulse oximeter 126(3) may be configured to provide sensor data 128 that is indicative of a cardiac pulse rate and data indicative of oxygen saturation of the user's 102 blood. For example, the pulse oximeter 126(3) may use one or more light emitting diodes (LEDs) and corresponding detectors to determine changes in apparent color of the blood of the user 102 resulting from oxygen binding with hemoglobin in the blood, providing information about oxygen saturation. Changes over time in apparent reflectance of light emitted by the LEDs may be used to determine cardiac pulse.

The sensors 126 may include one or more touch sensors 126(4). The touch sensors 126(4) may use resistive, capacitive, surface capacitance, projected capacitance, mutual capacitance, optical, Interpolating Force-Sensitive Resistance (IFSR), or other mechanisms to determine the position of a touch or near-touch of the user 102. For example, the IFSR may comprise a material configured to change electrical resistance responsive to an applied force. The location within the material of that change in electrical resistance may indicate the position of the touch.

One or more microphones 126(5) may be configured to acquire information about sound present in the environment. In some implementations, a plurality of microphones 126(5) may be used to form the microphone array 112. As described above, the microphone array 112 may implement beamforming techniques to provide for directionality of gain.

A temperature sensor (or thermometer) 126(6) may provide information indicative of a temperature of an object. The temperature sensor 126(6) in the computing device may be configured to measure ambient air temperature proximate to the user 102, the body temperature of the user 102, and so forth. The temperature sensor 126(6) may comprise a silicon bandgap temperature sensor, thermistor, thermocouple, or other device. In some implementations, the temperature sensor 126(6) may comprise an infrared detector configured to determine temperature using thermal radiation.

The sensors 126 may include one or more light sensors 126(7). The light sensors 126(7) may be configured to provide information associated with ambient lighting conditions such as a level of illumination. The light sensors 126(7) may be sensitive to wavelengths including, but not limited to, infrared, visible, or ultraviolet light. In contrast to a camera, the light sensor 126(7) may typically provide a sequence of amplitude (magnitude) samples and color data while the camera provides a sequence of two-dimensional frames of samples (pixels).

One or more radio frequency identification (RFID) readers 126(8), near field communication (NFC) systems, and so forth, may also be included as sensors 126. The user 102, objects around the computing device, locations within a building, and so forth, may be equipped with one or more radio frequency (RF) tags. The RF tags are configured to emit an RF signal. In one implementation, the RF tag may be a RFID tag configured to emit the RF signal upon activation by an external signal. For example, the external signal may comprise a RF signal or a magnetic field configured to energize or activate the RFID tag. In another implementation, the RF tag may comprise a transmitter and a power source configured to power the transmitter. For example, the RF tag may comprise a Bluetooth Low Energy (BLE) transmitter and battery. In other implementations, the tag may use other techniques to indicate its presence. For example, an acoustic tag may be configured to generate an ultrasonic signal, which is detected by corresponding acoustic receivers. In yet another implementation, the tag may be configured to emit an optical signal.

One or more RF receivers 126(9) may also be included as sensors 126. In some implementations, the RF receivers 126(9) may be part of transceiver assemblies. The RF receivers 126(9) may be configured to acquire RF signals associated with Wi-Fi, Bluetooth, ZigBee, Z-Wave, 3G, 4G, LTE, or other wireless data transmission technologies. The RF receivers 126(9) may provide information associated with data transmitted via radio frequencies, signal strength of RF signals, and so forth. For example, information from the RF receivers 126(9) may be used to facilitate determination of a location of the computing device, and so forth.

The sensors 126 may include one or more accelerometers 126(10). The accelerometers 126(10) may provide information such as the direction and magnitude of an imposed acceleration, tilt relative to local vertical, and so forth. Data such as rate of acceleration, determination of changes in direction, speed, tilt, and so forth, may be determined using the accelerometers 126(10).

A gyroscope 126(11) provides information indicative of rotation of an object affixed thereto. For example, the gyroscope 126(11) may indicate whether the device has been rotated.

A magnetometer 126(12) may be used to determine an orientation by measuring ambient magnetic fields, such as the terrestrial magnetic field. For example, output from the magnetometer 126(12) may be used to determine whether the device containing the sensor 126, such as the computing device 108, has changed orientation or otherwise moved. In other implementations, the magnetometer 126(12) may be configured to detect magnetic fields generated by another device.

A glucose sensor 126(13) may be used to determine a concentration of glucose within the blood or tissues of the user 102. For example, the glucose sensor 126(13) may comprise a near infrared spectroscope that determines a concentration of glucose or glucose metabolites in tissues. In another example, the glucose sensor 126(13) may comprise a chemical detector that measures presence of glucose or glucose metabolites at the surface of the user's skin.

A location sensor 126(14) is configured to provide information indicative of a location. The location may be relative or absolute. For example, a relative location may indicate “kitchen”, “bedroom”, “conference room”, and so forth. In comparison, an absolute location is expressed relative to a reference point or datum, such as a street address, geolocation comprising coordinates indicative of latitude and longitude, grid square, and so forth. The location sensor 126(14) may include, but is not limited to, radio navigation-based systems such as terrestrial or satellite-based navigational systems. The satellite-based navigation system may include one or more of a Global Positioning System (GPS) receiver, a Global Navigation Satellite System (GLONASS) receiver, a Galileo receiver, a BeiDou Navigation Satellite System (BDS) receiver, an Indian Regional Navigational Satellite System, and so forth. In some implementations, the location sensor 126(14) may be omitted or operate in conjunction with an external resource such as a cellular network operator providing location information, or Bluetooth beacons.

A fingerprint sensor 126(15) is configured to acquire fingerprint data. The fingerprint sensor 126(15) may use an optical, ultrasonic, capacitive, resistive, or other detector to obtain an image or other representation of features of a fingerprint. For example, the fingerprint sensor 126(15) may comprise a capacitive sensor configured to generate an image of the fingerprint of the user 102.

A proximity sensor 126(16) may be configured to provide sensor data 128 indicative of one or more of a presence or absence of an object, a distance to the object, or characteristics of the object. The proximity sensor 126(16) may use optical, electrical, ultrasonic, electromagnetic, or other techniques to determine a presence of an object. For example, the proximity sensor 126(16) may comprise a capacitive proximity sensor configured to provide an electrical field and determine a change in electrical capacitance due to presence or absence of an object within the electrical field.

An image sensor 126(17) comprises an imaging element to acquire images in visible light, infrared, ultraviolet, and so forth. For example, the image sensor 126(17) may comprise a complementary metal oxide (CMOS) imaging element or a charge coupled device (CCD).

The sensors 126 may include other sensors 126(S) as well. For example, the other sensors 126(S) may include strain gauges, anti-tamper indicators, and so forth. For example, strain gauges or strain sensors may be embedded within the wearable device 104 and may be configured to provide information indicating that at least a portion of the wearable device 104 has been stretched or displaced such that the wearable device 104 may have been donned or doffed.

In some implementations, the sensors 126 may include hardware processors, memory, and other elements configured to perform various functions. Furthermore, the sensors 126 may be configured to communicate by way of a network or may couple directly with the other devices.

The computing device may include or may couple to one or more output devices 134. The output devices 134 are configured to generate signals which may be perceived by the user 102, detectable by the sensors 126, or a combination thereof.

Haptic output devices 134(1) are configured to provide a signal, which results in a tactile sensation to the user 102. The haptic output devices 134(1) may use one or more mechanisms such as electrical stimulation or mechanical displacement to provide the signal. For example, the haptic output devices 134(1) may be configured to generate a modulated electrical signal, which produces an apparent tactile sensation in one or more fingers of the user 102. In another example, the haptic output devices 134(1) may comprise piezoelectric or rotary motor devices configured to provide a vibration that may be felt by the user 102.

One or more audio output devices 134(2) are configured to provide acoustic output. The acoustic output includes one or more of infrasonic sound, audible sound, or ultrasonic sound. The audio output devices 134(2) may use one or more mechanisms to generate the acoustic output. These mechanisms may include, but are not limited to, the following: voice coils, piezoelectric elements, magnetorestrictive elements, electrostatic elements, and so forth. For example, a piezoelectric buzzer or a speaker may be used to provide acoustic output by an audio output device 134(2).

The display devices 132(3) may be configured to provide output that may be seen by the user 102 or detected by a light-sensitive detector such as the image sensor 126(17) or light sensor 126(7). The output may be monochrome or color. The display devices 132(3) may be emissive, reflective, or both. An emissive display device 132(3), such as using LEDs, is configured to emit light during operation. In comparison, a reflective display device 132(3), such as using an electrophoretic element, relies on ambient light to present an image. Backlights or front lights may be used to illuminate non-emissive display devices 132(3) to provide visibility of the output in conditions where the ambient light levels are low.

The display mechanisms of display devices 132(3) may include, but are not limited to, micro-electromechanical systems (MEMS), spatial light modulators, electroluminescent displays, quantum dot displays, liquid crystal on silicon (LCOS) displays, cholesteric displays, interferometric displays, liquid crystal displays, electrophoretic displays, LED displays, and so forth. These display mechanisms are configured to emit light, modulate incident light emitted from another source, or both. The display devices 132(3) may operate as panels, projectors, and so forth.

The display devices 132(3) may be configured to present images. For example, the display devices 132(3) may comprise a pixel-addressable display. The image may comprise at least a two-dimensional array of pixels or a vector representation of an at least two-dimensional image.

In some implementations, the display devices 132(3) may be configured to provide non-image data, such as text or numeric characters, colors, and so forth. For example, a segmented electrophoretic display device 132(3), segmented LED, and so forth, may be used to present information such as letters or numbers. The display devices 132(3) may also be configurable to vary the color of the segment, such as using multicolor LED segments.

Other output devices 134(T) may also be present. For example, the other output devices 134(T) may include scent dispensers.

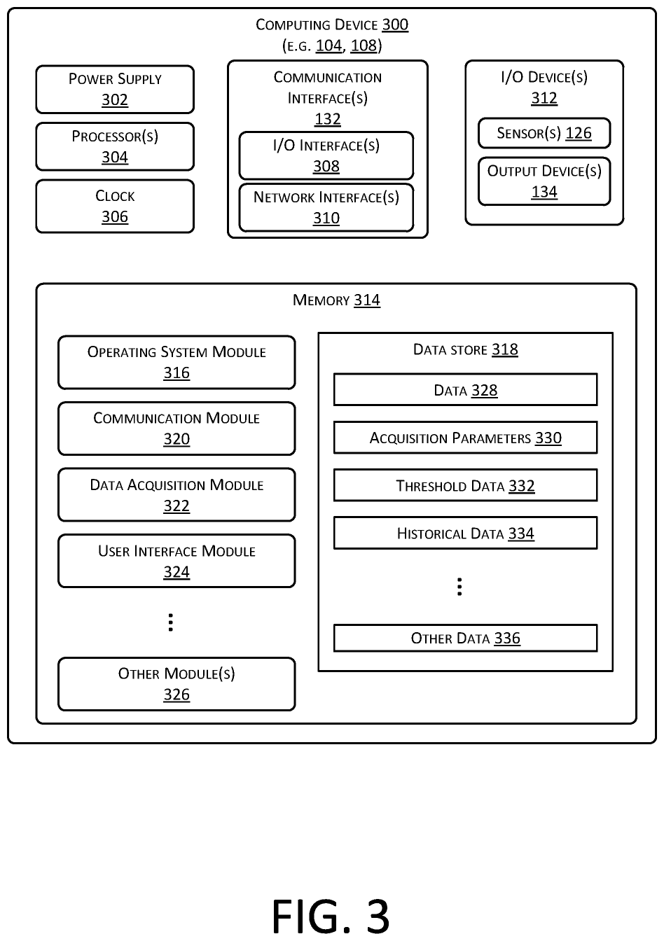

FIG. 3 illustrates a block diagram of a computing device 300 configured to support operation of the system 100. As described above, the computing device 300 may be the wearable device 104, the computing device 108, and so forth.

One or more power supplies 302 are configured to provide electrical power suitable for operating the components in the computing device 300. In some implementations, the power supply 302 may comprise a rechargeable battery, fuel cell, photovoltaic cell, power conditioning circuitry, wireless power receiver, and so forth.

The computing device 300 may include one or more hardware processors 304 (processors) configured to execute one or more stored instructions. The processors 304 may comprise one or more cores. One or more clocks 306 may provide information indicative of date, time, ticks, and so forth. For example, the processor 304 may use data from the clock 306 to generate a timestamp, trigger a preprogrammed action, and so forth.

The computing device 300 may include one or more communication interfaces 132 such as input/output (I/O) interfaces 308, network interfaces 310, and so forth. The communication interfaces 132 enable the computing device 300, or components thereof, to communicate with other devices or components. The communication interfaces 132 may include one or more I/O interfaces 308. The I/O interfaces 308 may comprise interfaces such as Inter-Integrated Circuit (I2C), Serial Peripheral Interface bus (SPI), Universal Serial Bus (USB) as promulgated by the USB Implementers Forum, RS-232, and so forth.

The I/O interface(s) 308 may couple to one or more I/O devices 312. The I/O devices 312 may include input devices such as one or more of the sensors 126. The I/O devices 312 may also include output devices 134 such as one or more of an audio output device 134(2), a display device 134(3), and so forth. In some embodiments, the I/O devices 312 may be physically incorporated with the computing device 300 or may be externally placed.

The network interfaces 310 are configured to provide communications between the computing device 300 and other devices, such as the sensors 126, routers, access devices, and so forth. The network interfaces 310 may include devices configured to couple to wired or wireless personal area networks (PANs), local area networks (LANs), wide area networks (WANs), and so forth. For example, the network interfaces 310 may include devices compatible with Ethernet, Wi-Fi, Bluetooth, ZigBee, 4G, 5G, LTE, and so forth.

The computing device 300 may also include one or more busses or other internal communications hardware or software that allow for the transfer of data between the various modules and components of the computing device 300.

As shown in FIG. 3, the computing device 300 includes one or more memories 314. The memory 314 comprises one or more computer-readable storage media (CRSM). The CRSM may be any one or more of an electronic storage medium, a magnetic storage medium, an optical storage medium, a quantum storage medium, a mechanical computer storage medium, and so forth. The memory 314 provides storage of computer-readable instructions, data structures, program modules, and other data for the operation of the computing device 300. A few example functional modules are shown stored in the memory 314, although the same functionality may alternatively be implemented in hardware, firmware, or as a system on a chip (SOC).

The memory 314 may include at least one operating system (OS) module 316. The OS module 316 is configured to manage hardware resource devices such as the I/O interfaces 308, the network interfaces 310, the I/O devices 312, and provide various services to applications or modules executing on the processors 304. The OS module 316 may implement a variant of the FreeBSD operating system as promulgated by the FreeBSD Project; other UNIX or UNIX-like operating system; a variation of the Linux operating system as promulgated by Linus Torvalds; the Windows operating system from Microsoft Corporation of Redmond, Wash., USA; the Android operating system from Google Corporation of Mountain View, Calif., USA; the iOS operating system from Apple Corporation of Cupertino, Calif., USA; or other operating systems.

Also stored in the memory 314 may be a data store 318 and one or more of the following modules. These modules may be executed as foreground applications, background tasks, daemons, and so forth. The data store 318 may use a flat file, database, linked list, tree, executable code, script, or other data structure to store information. In some implementations, the data store 318 or a portion of the data store 318 may be distributed across one or more other devices including the computing devices 300, network attached storage devices, and so forth.

A communication module 320 may be configured to establish communications with one or more of other computing devices 300, the sensors 126, and so forth. The communications may be authenticated, encrypted, and so forth. The communication module 320 may also control the communication interfaces 132.

The memory 314 may also store a data acquisition module 322. The data acquisition module 322 is configured to acquire raw audio data 118, sensor data 126, and so forth. In some implementations the data acquisition module 322 may be configured to operate the one or more sensors 126, the microphone array 112, and so forth. For example, the data acquisition module 322 may determine that the sensor data 128 satisfies a trigger event. The trigger event may comprise values of sensor data 128 for one or more sensors 126 exceeding a threshold value. For example, if pulse oximeter 126(3) on the wearable device 104 indicates that the pulse of the user 102 has exceeded a threshold value, the microphone array 112 may be operated to generate raw audio data 118.

In another example, the data acquisition module 322 on the wearable device 104 may receive instructions from the computing device 108 to obtain raw audio data 118 at a specified interval, at a scheduled time, and so forth. For example, the computing device 108 may send instructions to acquire raw audio data 118 for 60 seconds every 540 seconds. The raw audio data 118 may then be processed with the voice activity detector module 120 to determine is speech 116 is present. If speech 116 is detected, the first audio data 124 may be obtained and then sent to the computing device 108.

A user interface module 324 provides a user interface using one or more of the I/O devices 312. The user interface module 324 may be used to obtain input from the user 102, present information to the user 102, and so forth. For example, the user interface module 324 may present a graphical user interface on the display device 134(3) and accept user input using the touch sensor 126(4).

One or more other modules 326, such as the voice activity detector module 120, the audio preprocessing module 122, the data transfer module 130, the turn detection module 136, the speech identification module 138, the audio feature module 144, the feature analysis module 148, the sensor data analysis module 152, the advisory module 156, and so forth may also be stored in the memory 314.

Data 328 may be stored in the data store 318. For example, the data 328 may comprise one or more of raw audio data 118, first audio data 124, sensor data 128, user profile data 140, second audio data 142, sentiment data 150, user status data 154, advisory data 158, output data 160, and so forth.

One or more acquisition parameters 330 may be stored in the memory 314. The acquisition parameters 330 may comprise parameters such as audio sample rate, audio sample frequency, audio frame size, and so forth.

Threshold data 332 may be stored in the memory 314. For example, the threshold data 332 may specify one or more thresholds used by the voice activity detector module 120 to determine if the raw audio data 118 includes speech 116.

The computing device 300 may maintain historical data 334. The historical data 334 may be used to provide information about trends or changes over time. For example, the historical data 334 may comprise an indication of sentiment data 150 on an hourly basis for the previous 90 days. In another example, the historical data 334 may comprise user status data 154 for the previous 90 days.

Other data 336 may also be stored in the data store 318.

In different implementations, different computing devices 300 may have different capabilities or capacities. For example, the computing device 108 may have significantly more processor 304 capability and memory 314 capacity compared to the wearable device 104. In one implementation, the wearable device 104 may determine the first audio data 124 and send the first audio data 124 to the computing device 108. In another implementation, the wearable device 104 may generate the sentiment data 150, advisory data 158, and so forth. Other combinations of distribution of data processing and functionality may be used in other implementations.

FIG. 4 illustrates at 400 parts of a conversation between the user 102 and a second person, according to one implementation. In this figure, time 402 increases down the page. A conversation 404 may comprise speech 116 produced by one or more people. For example, as shown here the user 102 may be talking with a second person. In another implementation, the conversation 404 may comprise speech 116 from the user 102 speaking to themselves. Several turns 406(1)-(4) of the conversation 404 are illustrated here. For example, a turn 406 may comprise a contiguous portion of speech 116 by a single person. In this example, the first turn 406(1) is the user 102 saying “Hello, thanks for coming in today.” while the second turn 406(2) is the second person responding with “Thank you for inviting me. I'm looking forward to . . . ”. The first turn 406(1) is a single sentence while the second turn 406(2) is several sentences.

The system 100 acquires the raw audio data 118 that is the used to determine the first audio data 124. The first audio data 124 is illustrated here as blocks, with different shading to indicate the respective speaker. For example, a block may be representative of a particular period of time, set of one or more frames of audio data, and so forth.

The turn detection module 136 may be used to determine the boundaries of each turn 406. For example, the turn detection module 136 may determine a turn 406 based on a change in the sound of who is speaking, on the basis of time, and so forth.

The speech identification module 138 is used to determine whether the portion of the first audio data 124, such as a particular turn 406, is speech 116 from the user 102. In determining the second audio data 142, the audio for turns 406 that are not associated with the user 102 are omitted. As a result, the second audio data 142 may consist of audio data that is deemed to represent speech 116 from the user 102. The system 100 is thus prevented from processing speech 116 of the second person.

The second audio data 142 is processed and the sentiment data 150 is determined. The sentiment data 150 may be determined for various portions of the second audio data 142. For example, the sentiment data 150 may be determined for a particular turn 406 as illustrated here. In another example, the sentiment data 150 may be determined based on audio from more than one turn 406. As described above, the sentiment data 150 may be expressed as one or more of a valence value, activation value, dominance value, and so forth. These values may be used to determine a single value, such as a tone value or sentiment index. The sentiment data 150 may include one or more associated words 408, associated icons, associated colors, and so forth. For example, the combination of valence value, activation value, and dominance value, may describe a multidimensional space. Various volumes within this space may be associated with particular words. For example, within that multidimensional space, a valence value of +72, activation value of 57, and dominance value of 70 may describe a point that is within a volume that is associated with the words “professional” and “pleasant”. In another example, the point may be within a volume that is associated with a particular color, icon, and so forth.

In other implementations, other techniques may be used to determine sentiment data 150 from audio feature data 146 obtained from the second audio data 142. For example, a machine learning system comprising one or more of classifiers, neural networks, and so forth may be trained to associate particular audio features in the audio feature data 146 with particular associated words 408, associated icons, associated colors, and so forth.

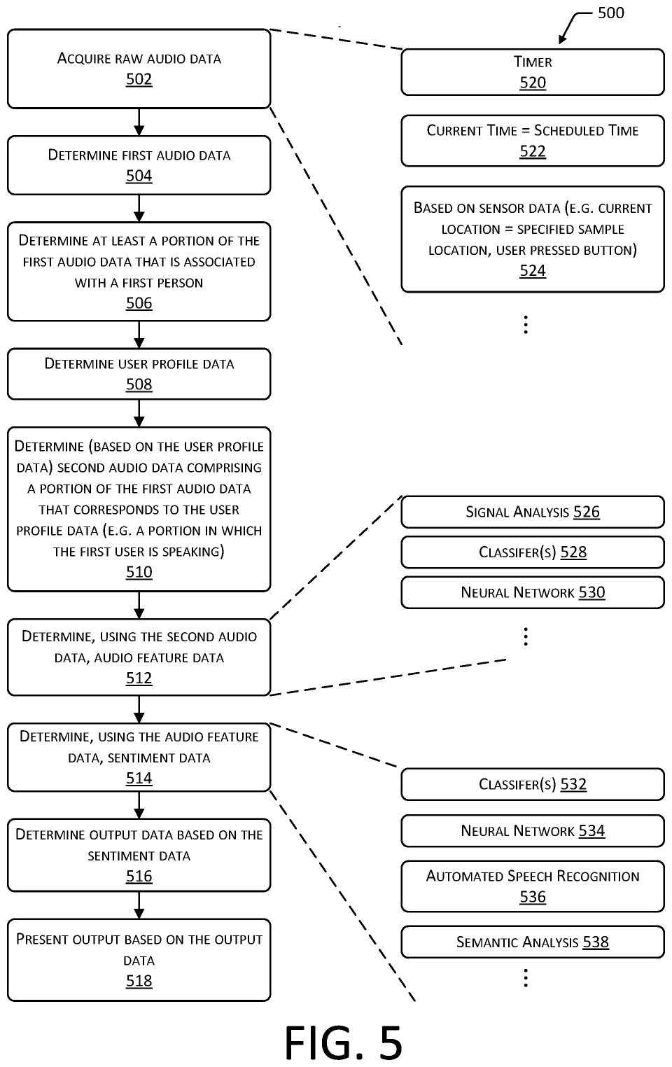

FIG. 5 illustrates a flow diagram 500 of a process of presenting output 162 based on sentiment data 150 obtained from analyzing a user's speech 116, according to one implementation. The process may be performed by one or more of the wearable device 104, the computing device 108, a server, or other device.

At 502 the raw audio data 118 is acquired. A determination may be made as to when to acquire the raw audio data 118. For example, the data acquisition module 322 of the wearable device 104 may be configured to operate the microphone array 112 and acquire the raw audio data 118 when a timer 520 expires, when a current time on the clock 306 equals a scheduled time as shown at 522, based on sensor data 128 as shown at 524, and so forth. For example, the sensor data 128 may indicate activation of a button 126(1), motion of the accelerometer 126(10) that exceeds a threshold value, and so forth. In some implementations combinations of various factors may be used to determine when to begin acquisition of the raw audio data 118. For example, the data acquisition module 322 may acquire raw audio data 118 every 540 seconds when the sensor data 128 indicates the wearable device 104 is in a particular location that has been approved by the user 102.

At 504 the first audio data 124 is determined. For example, the raw audio data 118 may be processed by the voice activity detector module 120 to determine if speech 116 is present. If no speech 116 is determined to be present, the non-speech raw audio data may be discarded. If no speech 116 is determined for a threshold period of time, acquisition of the raw audio data 118 may cease. The raw audio data 118 that contains speech 116 may be processed by the audio preprocessing module 122 to determine the first audio data 124. For example, a beamforming algorithm may be used to produce a microphone pattern 114 in which the signal to noise ratio for the speech 116 from the user 102 is improved.

At 506 at least a portion of the first audio data 124 that is associated with a first person is determined. For example, the turn detection module 136 may determine that a first portion of the first audio data 124 comprises the first turn 406(1).

At 508 user profile data 140 is determined. For example, the user profile data 140 for the user 102 registered to the wearable device 104 may be retrieved from storage. The user profile data 140 may comprise information that is obtained from the user 102 during an enrollment process. During the enrollment process, the user 102 may provide samples of their speech 116 that are then used to determine characteristics that are indicative of the user's 102 speech 116. For example, the user profile data 140 may be generated by processing the speech 116 obtained during enrollment with a convolutional neural network that is trained to determine feature vectors representative of the speech 116, a classifier, by applying signal analysis algorithms, and so forth.

At 510, based on the user profile data 140, the second audio data 142 is determined. The second audio data 142 comprises the portion(s) of the first audio data 124 that are associated with the user 102. For example, the second audio data 142 may comprise that portion of the first audio data 124 in which a turn 406 contains a voice that corresponds within a threshold level to the user profile data 140.

At 512 the audio feature data 146 is determined using the second audio data 142. The audio feature module 144 may use one or more techniques, such as one or more signal analysis 526 techniques, one or more classifiers 528, one or more neural networks 530, and so forth. The signal analysis 526 techniques may determine information about the frequency, timing, energy, and so forth of the signals represented in the second audio data 142. The audio feature module 144 may utilize one or more neural networks 530 that are trained to determine audio feature data 146 such as vectors in a multidimensional space that are representative of the speech 116.

At 514 the audio feature data 146 is used to determine the sentiment data 150. The feature analysis module 148 may use one or more techniques, such as one or more classifiers 532, neural networks 534, automated speech recognition 536, semantic analysis 538, and so forth to determine the sentiment data 150. For example, the audio feature data 146 may be processed by a classifier 532 to produce sentiment data 150 that indicates a value of either “happy” or “sad”. In another example, the audio feature data 146 may be processed by one or more neural networks 534 that have been trained to associate particular audio features with particular emotional states.

The determination of the sentiment data 150 may be representative of emotional prosody. In other implementations the words spoken and their meaning may be used to determine the sentiment data 150. For example, the automated speech recognition 536 may determine the words in the speech 116, while the semantic analysis 538 may determine what the intent of those words is. For example, the use of particular words, such as compliments, profanity, insults, and so forth may be used to determine the sentiment data 150.

At 516 the output data 160 is generated based on the sentiment data 150. For example, the output data 160 may comprise instructions that direct a display device 134(3) to present a numeric value, particular color, or other interface element 166 in a user interface 164.

At 518 output 162 is presented based on the output data 160. For example, the user interface 164 is shown on the display device 134(3) of the computing device 108.

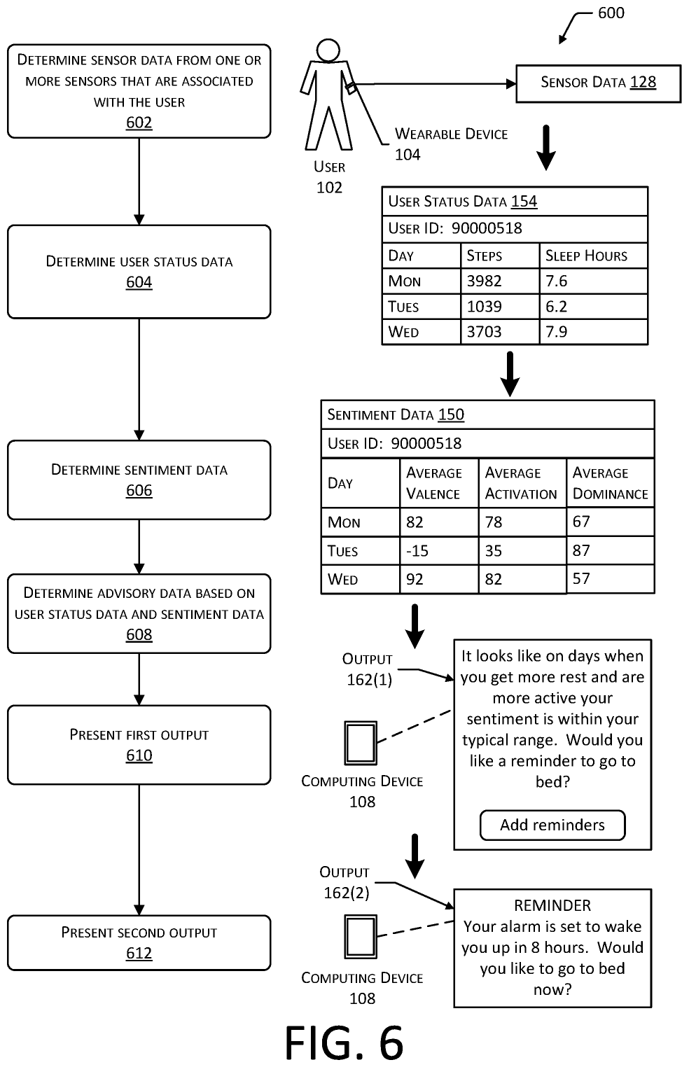

FIG. 6 illustrates a scenario 600 in which user status data 154 such as information about the user's health is combined with the sentiment data 150 to provide advisory output, according to one implementation.

At 602 the sensor data 128 is determined from one or more sensors 126 that are associated with the user 102. For example, after receiving approval from the user 102, the sensors 126 in the wearable device 104, the computing device 108, internet enabled devices, and so forth may be used to acquire sensor data 128.

At 604 the sensor data 128 is processed to determine user status data 154. The user status data 154 may be indicative of information about information of the user 102 such as biomedical status, movement, use of other devices, and so forth. For example, the user status data 154 illustrated in this figure includes information about the number of steps and the number of hours slept for Monday, Tuesday, and Wednesday. Continuing the example, the user 102 slept only 6.2 hours on Tuesday and did not take as many steps.

At 606 the sentiment data 150 is determined. As described above, the speech 116 of the user 102 is processed to determine information about the emotional state indicated in their voice. For example, the sentiment data 150 illustrated here includes the average valence, average activation, and average dominance values for Monday, Tuesday, and Wednesday. Continuing the example, the sentiment data 150 indicates that on Tuesday the user 102 experienced a negative average valence, a decreased average activation, and an increased average dominance.

At 608 the advisory module 156 determines advisory data 158 based at least in part on the sentiment data 150 and the user status data 154. For example, based on the information available, when the user 102 gets less than 7 hours of sleep their overall emotional state as indicated by their speech 116 is outside of the user's 102 typical range compared to those days when more than 7 hours of sleep take place. The advisory data 158 may then be used to generate output data 160. For example, the output data 160 may comprise an advisory asking if the user 102 if they would like to be reminded to go to bed.

At 610 first output 162 based on the output data 160 is presented. For example, output 162(1) in the form of a graphical user interface may be presented on the display device 134(3) of the computing device 108, asking the user 102 if they would like to add a reminder to go to bed.

At 612 second output 162 is presented. For example, later on that evening at the designated time, a reminder may be presented on the display device 134(3) advising the user 102 to go to bed.

By using the system 100, the overall well being of the user 102 may be improved. As shown in this illustration, the system 100 informs the user 102 as to a correlation between their amount of rest and their mood the next day. By reminding the user 102 to rest, and the user 102 acting on this reminder, the mood of the user 102 the next day may be improved.

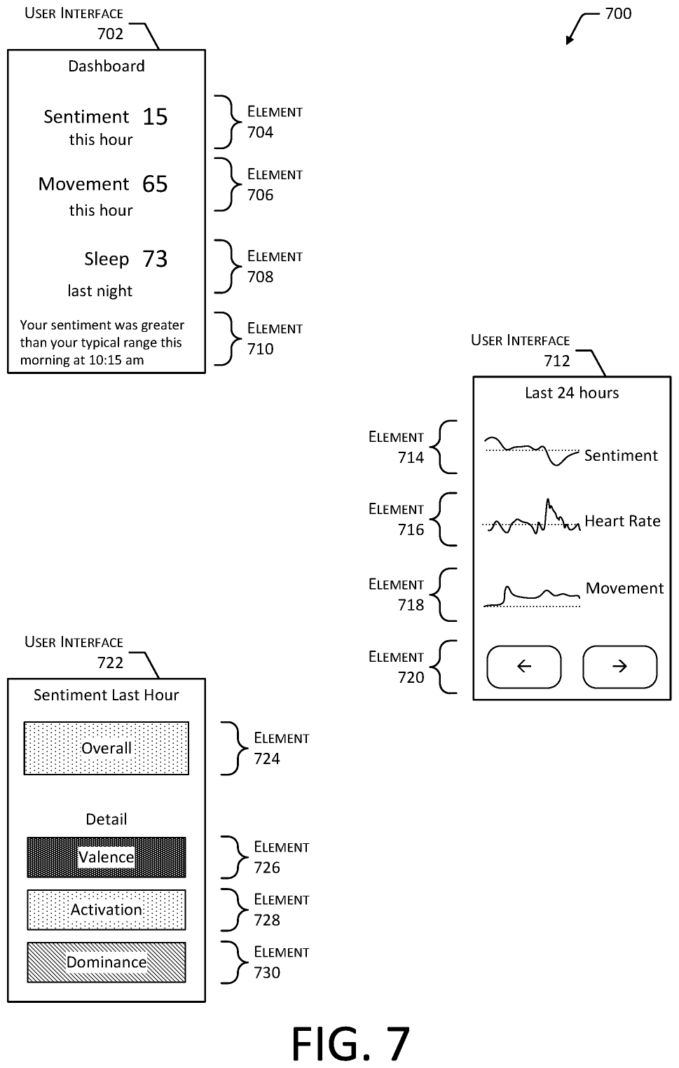

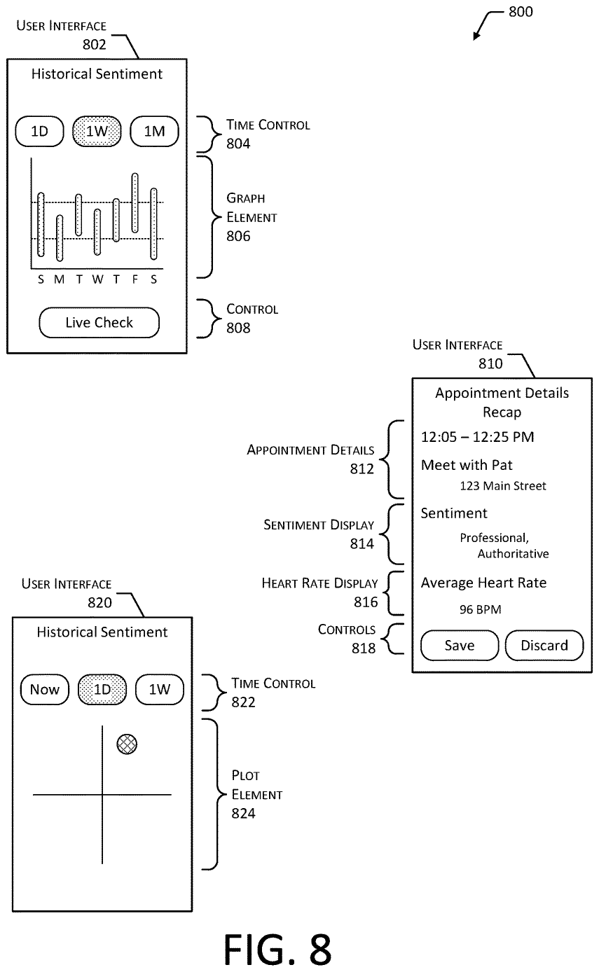

FIGS. 7 and 8 illustrate several examples of user interfaces 164 of output 162 presented to the user 102 that is based at least in part on the sentiment data 150, according to some implementations. The sentiment data 150 may be non-normative. The output 162 may be configured to present interface elements 166 that avoid a normative presentation. For example, the output 162 may be representative of sentiment of the user relative to their typical range or baseline values, as compared to indicating that they are “happy” or “sad”.

A first user interface 702 depicts a dashboard presentation in which several elements 704-710 provide information based on the sentiment data 150 and the user status data 154. User interface element 704 depicts a sentiment value for the past hour. For example, the sentiment value may be aggregated based on one or more values expressed in the sentiment data 150. The sentiment values may be non-normative or may be configured to avoid a normative assessment. For example, numeric sentiment values may be indicated in a range of 1 to 16, rather than 1 to 100 to minimize a normative assessment that a sentiment value of “100” is better than a sentiment value of “35”. The sentiment data 150 may be relative to a baseline or typical range associated with the user 102. User interface element 706 depicts a movement value indicative of movement of the user 102 for the past hour. User interface element 708 depicts a sleep value for the previous night. For example, the sleep value may be based on sleep duration, movement during sleep, and so forth. User interface element 710 shows summary information based on the sentiment data 150, indicating that this morning the user's 102 overall sentiment was greater than their typical range at a particular time.

A second user interface 712 depicts line graphs depicting historical data 334 over the past 24 hours. User interface element 714 depicts a line graph of sentiment values over the past 24 hours. User interface element 716 depicts a line graph of heart rate over the past 24 hours. User interface element 718 depicts a line graph of movement over the past 24 hours. The second user interface 712 allows the user 102 to compare these different data sets and determine if there is a correspondence between them. User interface element 720 comprises a pair of user controls, allowing the user 102 change the time span or date for the data presented in the graphs.

A third user interface 722 depicts information about sentiment as colors in the user interface. User interface element 724 shows a colored area in the user interface 722 in which the color is representative of overall sentiment for the last hour. For example, the sentiment data 150 may indicate a sentiment index of 97 based on speech 116 uttered during the last hour. The color green may be associated with sentiment index values of between 90 and 100. As a result, in this example the sentiment index of 97 results in the user interface element 724 being green.

A detail section includes several user interface elements 726-730 that provide colored indicators for particular emotional primitives indicated in the sentiment data 150. For example, user interface element 726 presents a color that is selected based on the valence value, user interface element 728 presents a color that is selected based on the activation value, and the user interface element 730 presents a color that is selected based on the dominance value.

FIG. 8 depicts a user interface 802 in which historical sentiment data is presented in a bar chart. In this user interface 802, a time control 804 allows the user 102 to select what time span of sentiment data 150 they wish to view, such as one day “1D”, one week “1 W”, or one month “1M”. A graph element 806 presents information based on the sentiment data 150 for the selected time span. For example, the graph element 806 may present an average overall sentiment index for each day, a minimum and maximum sentiment index for each day, and so forth. In this illustration, the graph element 806 each day is represented by a bar which indicates a daily minimum and maximum of overall sentiment for that day. Also depicted in the graph element 806 as dotted lines are an upper limit and a lower limit of a typical range of overall sentiment for the user 102.

A control 808 allows the user 102 to perform a live check, initiating acquisition of raw audio data 118 for subsequent processing and generation of sentiment data 150. For example, after the user 102 activates the control 808, the user interface 802 may present output 162 such as a numeric output of sentiment index, a user interface element having a color that is based on the sentiment data 150, and so forth. In another implementation the live check may be initiated by the user 102 operating a control on the wearable device 104. For example, the user 102 may press a button on the wearable device 104 that initiates acquisition of raw audio data 118 that is subsequently processed.

User interface 810 provides recap information about sentiment data 150 associated with a particular appointment. The data 328 stored by, or accessible to, the system 100 may include appointment data such as the user's calendar of scheduled appointments. The appointment data may include one or more of appointment type, appointment subject, appointment location, appointment start time, appointment end time, appointment duration, appointment attendee data, or other data. For example, the appointment attendee data may comprise data indicative of invitees to the appointment.

The appointment data may be used to scheduled acquisition of raw audio data 118. For example, the user 102 may configure the system 100 to collect raw audio data 118 during particular appointments. The user interface 810 shows the calendar view with appointment details 812 such as time, location, subject, and so forth. The user interface 810 also includes sentiment display 814, showing associated words 408 of the sentiment data 150 for the time span associated with the appointment. For example, during this appointment the user 102 appeared to sound “professional” and “authoritative”. Also presented is a heart rate display 816 that indicates average pulse during the time span of the appointment. Controls 818 are also present that allow the user 102 to save or discard the information presented in the sentiment display 814. For example, the user 102 may choose to save the information for later reference.

FIG. 8 also depicts a user interface 820 with a time control 822 and a plot element 824. The time control 822 allows the user 102 to select what time span of sentiment data 150 they wish to view, such as “now”, one day “1D”, one week “1 W”, and so forth. The plot element 824 presents information along one or more axes based on the sentiment data 150 for the selected time span. For example, the plot element 824 depicted here includes two mutually orthogonal axes. Each axis may correspond to a particular metric. For example, the horizontal axis is indicative of valence while the vertical axis is indicative of activation. Indicia, such as a circle, may indicate the sentiment data for the select period of time with respect to these axes. In one implementation, the presentation of the plot element 824 may be such that a typical value associated with the user 102 is represented as a center of the chart, origin, intersection of the axes, and so forth. With this implementation, by observing the relative displacement of the indicia that is based on sentiment data 150, the user 102 may be able to see how their sentiment for the selected time span differs from their typical sentiment.

In these illustrations, the various time spans, such as previous hour, previous 24 hours, and so forth, are used by way of illustration and not necessarily as limitations. It is understood that other time spans may be used. For example, the user 102 may be provided with controls that allow for the selection of different time spans. While graphical user interfaces are depicted, it is understood that other user interfaces may be used. For example, a vocal user interface may be used to provide information to the user 102. In another example, a haptic output device 134(1) may provide a haptic output to the user 102 when one or more values in the sentiment data 150 exceed one or more threshold values.

The processes discussed herein may be implemented in hardware, software, or a combination thereof. In the context of software, the described operations represent computer-executable instructions stored on one or more non-transitory computer-readable storage media that, when executed by one or more processors, perform the recited operations. Generally, computer-executable instructions include routines, programs, objects, components, data structures, and the like that perform particular functions or implement particular abstract data types. Those having ordinary skill in the art will readily recognize that certain steps or operations illustrated in the figures above may be eliminated, combined, or performed in an alternate order. Any steps or operations may be performed serially or in parallel. Furthermore, the order in which the operations are described is not intended to be construed as a limitation.

Embodiments may be provided as a software program or computer program product including a non-transitory computer-readable storage medium having stored thereon instructions (in compressed or uncompressed form) that may be used to program a computer (or other electronic device) to perform processes or methods described herein. The computer-readable storage medium may be one or more of an electronic storage medium, a magnetic storage medium, an optical storage medium, a quantum storage medium, and so forth. For example, the computer-readable storage media may include, but is not limited to, hard drives, optical disks, read-only memories (ROMs), random access memories (RAMs), erasable programmable ROMs (EPROMs), electrically erasable programmable ROMs (EEPROMs), flash memory, magnetic or optical cards, solid-state memory devices, or other types of physical media suitable for storing electronic instructions. Further, embodiments may also be provided as a computer program product including a transitory machine-readable signal (in compressed or uncompressed form). Examples of transitory machine-readable signals, whether modulated using a carrier or unmodulated, include, but are not limited to, signals that a computer system or machine hosting or running a computer program can be configured to access, including signals transferred by one or more networks. For example, the transitory machine-readable signal may comprise transmission of software by the Internet.

Separate instances of these programs can be executed on or distributed across any number of separate computer systems. Thus, although certain steps have been described as being performed by certain devices, software programs, processes, or entities, this need not be the case, and a variety of alternative implementations will be understood by those having ordinary skill in the art.

Additionally, those having ordinary skill in the art will readily recognize that the techniques described above can be utilized in a variety of devices, environments, and situations. Although the subject matter has been described in language specific to structural features or methodological acts, it is to be understood that the subject matter defined in the appended claims is not necessarily limited to the specific features or acts described. Rather, the specific features and acts are disclosed as illustrative forms of implementing the claims.

What is claimed is:

1. A system comprising:
a wearable device comprising:
a microphone array;
a first Bluetooth communication interface;
a first memory storing first computer-executable instructions; and
a first hardware processor that executes the first computer-executable instructions to:
acquire raw audio data using the microphone array;
determine first audio data comprising at least a portion of the raw audio data that is representative of speech;
encrypt the first audio data;
send, using the first Bluetooth communication interface, the encrypted first audio data to a second device;
the second device comprising:
a display device;
a second Bluetooth communication interface;
a second memory storing second computer-executable instructions; and
a second hardware processor that executes the second computer-executable instructions to:
receive, using the second Bluetooth communication interface, the encrypted first audio data from the wearable device;
decrypt the encrypted first audio data;
determine second audio data comprising a portion of the first audio data that is spoken by a wearer;
determine, using the second audio data, a first set of audio features;
determine, using the first set of audio features, sentiment data that is indicative of one or more characteristics of speech by the wearer; and
present a graphical user interface with the display device that is indicative of an emotional state that is determined to be conveyed by the wearer's speech.

2. The system of claim 1, wherein the one or more characteristics of speech comprise:
a valence value that is representative of a particular change in pitch of the wearer's voice over time;
an activation value that is representative of pace of the wearer's speech over time; and
a dominance value that is representative of rise and fall patterns of the pitch of the wearer's voice over time;
determine a sentiment value based on the valence value, the activation value, and the dominance value;
determine a color associated with the sentiment value; and
wherein the graphical user interface comprises an element presented with the color.

3. A system comprising:
a first device comprising:
an output device;
a first communication interface;
a first memory storing first computer-executable instructions; and
a first hardware processor that executes the first computer-executable instructions to:
receive, using the first communication interface, first audio data;
determine user profile data indicative of speech by a first user;
determine second audio data comprising a portion of the first audio data that corresponds to the user profile data;
determine a first set of audio features of the second audio data;
determine, using the first set of audio features, sentiment data;
determine output data based on the sentiment data; and
present, using the output device, a first output based on at least a portion of the output data.

4. The system of claim 3 further comprising:
a second device comprising:
a microphone;
a second communication interface;
a second memory storing second computer-executable instructions; and
a second hardware processor that executes the second computer-executable instructions to:
acquire raw audio data using the microphone;
determine, using a voice activity detection algorithm, at least a portion of the raw audio data that is representative of speech; and
send to the first device, using the second communication interface, the first audio data comprising the at least a portion of the raw audio data that is representative of speech.

5. The system of claim 3 further comprising:
a second device comprising:
one or more sensors comprising one or more of:
a heart rate monitor,
an oximeter,
an electrocardiograph,
a camera, or
an accelerometer,
a second communication interface;
a second memory storing second computer-executable instructions; and
a second hardware processor that executes the second computer-executable instructions to:
determine sensor data based on output from the one or more sensors;
send, using the second communication interface, at least a portion of the sensor data to the first device; and
the first hardware processor executes the first computer-executable instructions to:
determine the output data based at least in part on a comparison between the sentiment data associated with the first audio data obtained during a first period of time and the sensor data obtained during a second period of time.

6. The system of claim 3 further comprising:
the first hardware processor executes the first computer-executable instructions to:
determine at least a portion of the sentiment data exceeds a threshold value;
determine second output data;
send, using the first communication interface, the second output data to a second device;
the second device comprising:
a structure to maintain the second device proximate to the first user;
a second output device;
a second communication interface;
a second memory storing second computer-executable instructions; and
a second hardware processor that executes the second computer-executable instructions to:
receive, using the second communication interface, the second output data; and
present, using the second output device, a second output based on at least a portion of the second output data.

7. The system of claim 3 further comprising:
a second device comprising:
at least one microphone;
a second communication interface;
a second memory storing second computer-executable instructions; and
a second hardware processor that executes the second computer-executable instructions to:
acquire the first audio data using the at least one microphone; and
send, using the second communication interface, the first audio data to the first device.

8. The system of claim 3, wherein the sentiment data comprises one or more of:
a valence value that is representative of a particular change in pitch of the first user's voice over time;
an activation value that is representative of pace of the first user's speech over time; or
a dominance value that is representative of rise and fall patterns of the pitch of the first user's voice over time.

9. The system of claim 3, the first device further comprising:
a display device; and
wherein the sentiment data is based on one or more of a valence value, an activation value, or a dominance value; and
the first hardware processor executes the first computer-executable instructions to:
determine a color value, based on one or more of the valence value, the activation value, or the dominance value; and
determine, as the output, a graphical user interface comprising at least one element with the color value.

10. The system of claim 3, further comprising:
the first hardware processor executes the first computer-executable instructions to:
determine one or more words associated with the sentiment data; and
wherein the first output comprises the one or more words.

11. A method comprising:
acquiring first audio data;
determining first user profile data indicative of speech by a first user;
determining a portion of the first audio data that corresponds to the first user profile data;
determining, using the portion of the first audio data that corresponds to the first user profile data, a first set of audio features;
determining, using the first set of audio features, sentiment data;
determining output data based on the sentiment data; and
presenting, using an output device, a first output based on at least a portion of the output data.

12. The method of claim 11, further comprising:
determining, within the portion of the first audio data, a first time at which the first user begins to speak; and
determining, within the portion of the first audio data, a second time at which the first user ends speaking; and
wherein the determining the first set of audio features uses a portion of the first audio data that extends from the first time to the second time.

13. The method of claim 11, further comprising:
determining appointment data that comprises one or more of:
appointment type,
appointment subject,
appointment location,
appointment start time,
appointment end time,
appointment duration, or
appointment attendee data;
determining data acquisition criteria that specify one or more conditions during which acquisition of the first audio data is permitted; and
wherein the acquiring the first audio data is responsive to a comparison between at least a portion of the appointment data and at least a portion of the data acquisition criteria.

14. The method of claim 11, further comprising:
determining appointment data that comprises one or more of:
appointment start time,
appointment end time, or
appointment duration;
determining the first audio data was acquired between the appointment start time and the appointment end time; and
wherein the first output is presented with information about an appointment associated with the appointment data.

15. The method of claim 11, further comprising:
determining the first user is one or more of: proximate to, or in communication with, a second user during acquisition of the first audio data; and
wherein the output data is indicative of an interaction between the first user and the second user.

16. The method of claim 11, wherein:
the sentiment data is indicative of one or more emotions of the first user; and
the output data comprises speech recommendations to the first user.

17. The method of claim 11, further comprising:
based on the sentiment data, determining a score that is associated with the first user; and
wherein the output data is based at least in part on the score.

18. The method of claim 11, further comprising:
acquiring sensor data from one or more sensors that are associated with the first user;
determining user status data based on the sensor data; and
comparing the user status data with the sentiment data.

19. The method of claim 11, wherein the sentiment data comprises one or more values; and
wherein the output data comprises a graphical representation in which the one or more values are associated with one or more colors.

20. The method of claim 11, wherein the sentiment data comprises one or more values; and
determine one or more words associated with the one or more values; and
wherein the output data comprises the one or more words.
